(19) United States
(12) Patent Application Publication
(10) Pub. No.: US 2004/0128890 A1
(43) Pub. Date: Jul. 8, 2004

(54) Back illuminated ceiling mounted display panel

(76) Inventor: Douglas E. Wickwire, Lucas, TX (US)

Correspondence Address: John E. Vandigriff, 190 N. Stemmons Frwy., Lewisville, TX, 75067, US

(21) Appl. No.: 10/740,065

(22) Filed: Dec. 19, 2003

Related U.S. Application Data
(63) Continuation-in-part of application No. 10/097,290, filed on Mar. 13, 2002, now abandoned.

(51) Int. Cl. G09F 7/22

(52) U.S. Cl. 40/617

(57) ABSTRACT

A back illuminated ceiling mounted display panel attaches to the outside of the framework of ceiling panels and overlaps the grid of the framework to include a total covering of the ceiling light fixture with the panel on and or the panel off. The display attaches to either the outside or inside panel ceiling framework, and covers the actual frame of the ceiling fluorescent light box, or can attach to the frame of the light box. The attachment mechanism is a strip that clips the outer length of the framework of the ceiling panel to the frame of the fluorescent light box. When properly mounted, the strips are flush mounted on the ceiling grid system and attaches securely between the light box and the ceiling grid system, and or framework of the suspended ceiling.

### PRIOR APPLICATIONS

This is a Continuation-in-part of U.S. application Ser. No. 10/097,290, filed Mar. 13, 2002

### FIELD OF THE INVENTION

The invention relates to lighted displays, and more particularly to a display that is ceiling mounted in the panel opening of a dropped panel ceiling.

### BACKGROUND OF THE INVENTION

U.S. Pat. No. 4,290,218 is a replacement for a ceiling panel and uses incandescent lights. This patent represents a flat panel on the bottom of a ceiling unit. Retaining clips are used to attach the unit to the ceiling.

U.S. Pat. No. 4,528,764 is a light diffuser containing several translucent drop-in inserts. The first or innermost insert is a translucent diffuser sheet. There has to be an outer sheet to sandwich the film negative against the diffuser sheet. The various components are of conventional acrylic. The sidewall of the unit has a cutout with a reflective and translucent baffle seated inside. It is designed to direct light downward and defuse light. It includes at least one inclined side in order to gain a reflection through the cutout for a reflective means.

U.S. Pat. No. 5,274,938 has only a limited surface area because of its internal framing and limited window slots that strictly limit the amount of direct lighting on the display. The light units are mounted inside of the display.

### SUMMARY OF THE INVENTION

The invention is a back illuminated ceiling mounted display panel that attaches to the outside of the framework of ceiling panels and overlaps the grid of the framework to include a total covering of the ceiling light fixture with the panel on and or the panel off. The display attaches to the outside panel ceiling framework, and covers the actual frame of the ceiling fluorescent light box, or can attach to the frame of the light box.

The attachment mechanism is a strip that clips the outer length of the framework of the ceiling panel to the frame of the fluorescent light box. When properly mounted, the strips are flush mounted on the ceiling grid system and attaches securely between the light box and the ceiling grid system, and or framework of the suspended ceiling.

### BRIEF DESCRIPTION OF THE DRAWINGS

FIG. 1 shows a dropped panel ceiling with a ceiling mounted display panel of the present invention mounted in the one panel space;

FIG. 2 shows the dropped panel ceiling with the display panel in dashed lines, showing the lighting above the panel;

FIG. 3 shows the details of the display panel;

FIG. 3a shows a modification of the display panel;

FIG. 4 shows an end view of a mounting clip;

FIG. 5 shows a side view of a mounting clip;

FIG. 6 shows an end view of a display panel mounted in and secured to the grid strips of the ceiling grid;

FIG. 6a shows an alternate method of mounting the display panel.

FIG. 7 shows a ceiling mount light fixture with a lens panel, the fixture mounted in a dropped ceiling panel opening; and

FIG. 8 shows the fixture of FIG. 7 with a display panel replacing the lens panel.

### DESCRIPTION OF A PREFERRED EMBODIMENT

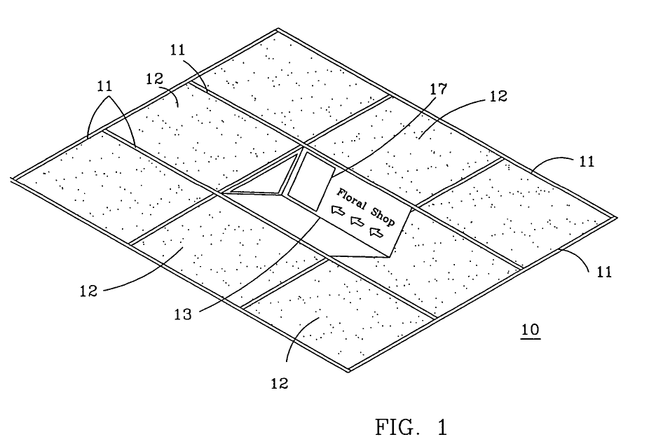

FIG. 1 shows a dropped panel ceiling 10 with a ceiling mounted display panel 13 of the present invention mounted in the one panel space. Dropped ceiling 10 has a frame of a plurality of strips 11 that form a grid or framework into which ceiling panels 12 are placed. One or more panels 12 may be removed and a display 13 may be mounted in each opening where a panel has been removed. Display panel 13 may have a removable panel holder 17 in which display may be placed without detaching the display 13 from it mounted position on the ceiling grid 11.

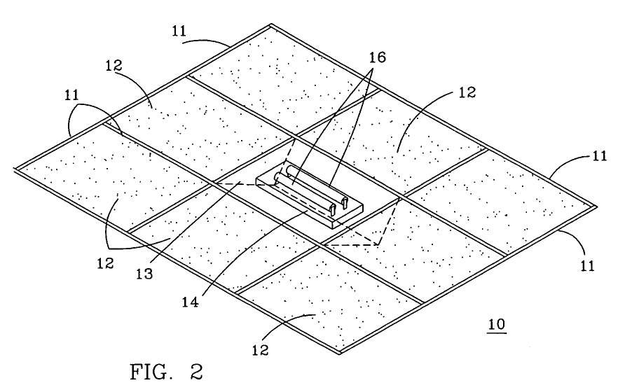

FIG. 2 shows the dropped panel ceiling 10 with the display panel 13 in dashed lines, and showing lighting fixture 14 above the panel. In dropped ceilings, there may be lighting above all the panels. There may be a light unit, such as light unit 14, with florescent tubes 16 for each panel, or there may be long florescent tubes that extend above several panels. If lighting is not required for each panel unit, then some of the panel units may not be clear or translucent.

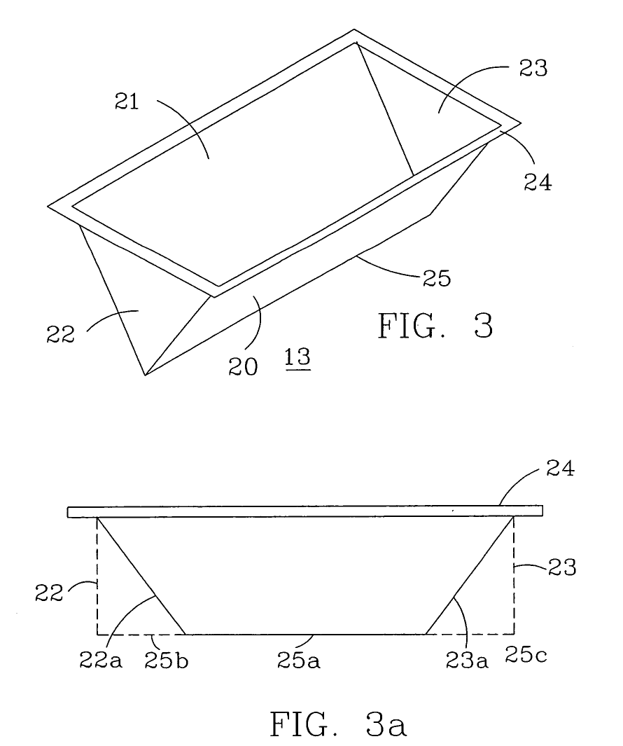

FIG. 3 shows the details of display panel 13. Panel 13 has two sides 20 and 21 that extend downward from the mounting frame 24, and join at a common end 25. Side panels 22 and 23 are triangular, and enclose the ends of panels 20 and 21. The four sides 20,21,22 and 23 form a four sided display panel, lighted from the inside by the fluorescent lights. In the embodiment of FIG. 3, the two sides 22 and 23 are vertical, but may be at an angle as shown in FIG. 3a. In FIG. 3a, the two sides may angled as shown by sides 22a and 23a. The original sides 22 and 23 are shown in dashed lines. The bottom edge 25 of FIG. 3 is shown shortened and designated as 25a, with the removed end portion 25b and 25c shown with dashed lines.

Light display 13 is solid in shape and has no holes in its structure. Graphics placed in the unit may be permanent or temporary. Typically, light display is usually a rectangular plastic molded piece, however it may take on any shape. The light display may be affixed to an additional unit making a trapezoid graphic display to be viewed from the top or the bottom. Typically the unit may be constructed from lexan or polybicarbonate or plexiglass, however there are numerous other materials that may be utilized.

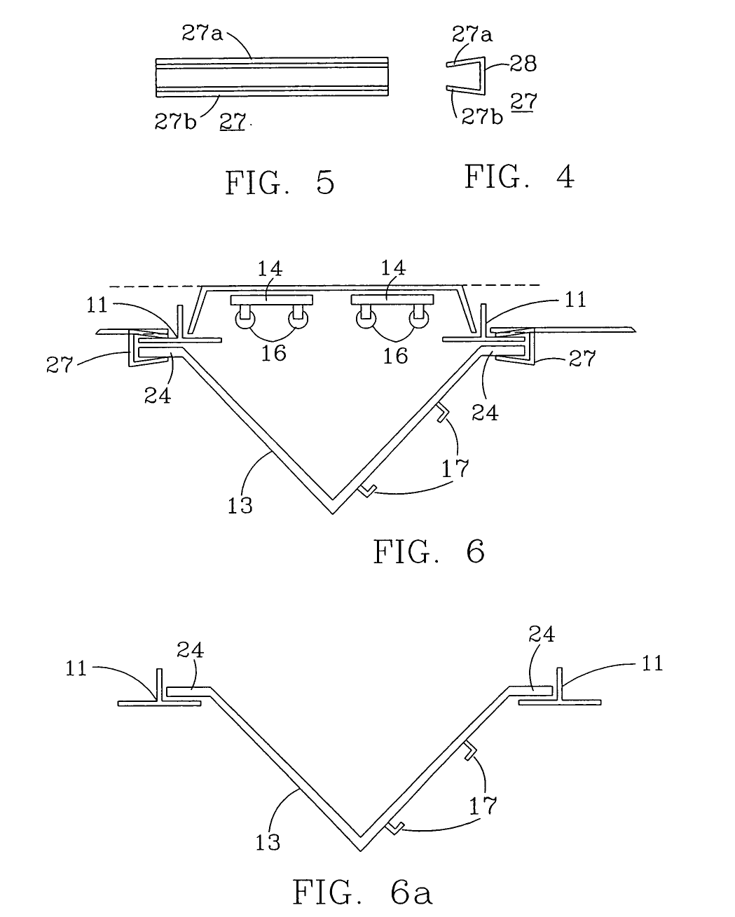

FIG. 4 shown an end view of a securing/mounting strip 27. A side view is shown in FIG. 5. Strip 27 has two sides 27a and 27b which are extend from back 28. Several strips 27 are used to hold the display panel 13, FIG. 3, in place when mounted on a ceiling grid.

The light display 13 may be both clear and or translucent white, however it may be colored or shaped to accommodate various items that may be displayed or advertised by it. Light Display 13 is fully enclosed except for the top, which will enclose around a light box, clipping on all sides of edge 24 with several elongated strip 27 that may be clear or transparent. There can be multiple elongated strips 27 on each side of the unit, however, typically there will be two on each long side and one on each end. All of these attach from the outside in and onto the framework of the ceiling grid 11 (FIGS. 1 and 2) or the actual fluorescent lighting system.

FIG. 6 shows a light panel 13 mounted into a grid 11 of a ceiling panel system. The edge 24 of the panel 13 is held in place against grid strips 11 by strips 27, sealing panel 13 over light fixtures 14 with tubes 16. A removable panel 17 holder is shown on one side of display 13.

FIG. 6a shows an alternate mounting method for the light panel 13. The side edges 24 are place up into frame or grid strips 11 and the edges 24 overlap and rest on grid strips 11, the same way a panel is mounted in grid strips 11.

One advantage of novel feature of the light panel 13, and it attachment strips if that the actual fluorescent lighting unit can be left intact and undisturbed either with its plastic lighting lens on or off. The light panel 13 attaches from the outside in leaving the ceiling panel framework and or the fluorescent lighting system in place and intact. This allows for the installation of both permanent and temporary information display units to be installed for a wide array of applications to include art, public information, advertisements, and any other type of visual representations.

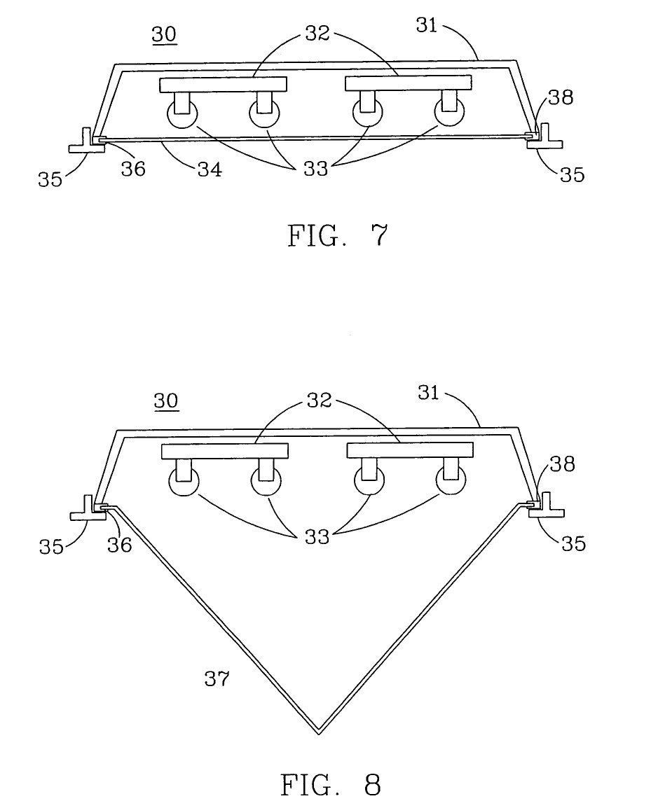

FIG. 7 shows a ceiling mount light fixture with a lens panel, the fixture mounted in a dropped ceiling panel opening. Light fixture 30 has a housing 31 with two lights 32 mounted there. Each light 32 has, for example, two light bulbs 33. Housing 31 is mounted in the dropped ceiling grid frame 35. A lens panel 34 is mounted in slots 36 which are in the panel frame 38. Panel frame 38 may be a part of light housing 31, or may be a separate frame mounted under housing 31.

FIG. 8 shows the fixture of FIG. 7 with a display panel 37 replacing the lens panel 34. Display panel 37 may be similar to display panel 13 illustrated in FIG. 3. The frame 24 on display panel 13 is mounted into the slots 36 of panel frame 38.

What is claimed:

1. A display device for use in combination with a dropped ceiling grid system, comprising:
a dropped ceiling framework including a support grid, said support grid having a plurality of openings therein, and panels mounted in the openings in the support grid, said framework having a top side and a bottom side;
a partially enclosed display having an opening therein corresponding to one of the openings in the support grids formed by the framework, said opening in said display having a mounting frame around the opening; and
mounting strips, each the length of said display, extending along the length of at least two sides of said display to secure said display by the mounting frame to the bottom side of the support grid adjacent to an opening where a panel has been removed.

2. The display device according to claim 1, wherein said display device has at least two sides at an angle downward from the mounting frame to permit viewing of the sides from a position beneath the display.

3. The display device according to claim 1, wherein said display device has at four sides at an angle downward from the mounting frame to permit viewing of the sides from a position beneath the display.

4. The display device according to claim 1, wherein said display is mounted below a light.

5. The display device according to claim 1, wherein said display is at least one of transparent and translucent.

6. The display device according to claim 1, wherein said display is of at least one color, and has information displayed thereon in at least one color different from the at least one color of the display.

7. The display device according to claim 1, including a mounting frame in which to place changeable displays.

8. A display device for use in combination with a dropped ceiling grid system, comprising:
a dropped ceiling framework including a support grid, said support grid having a plurality of openings therein, and panels mounted in the openings in the support grid, said framework having a top side and a bottom side;
a partially enclosed display having an opening therein corresponding to one of the openings in the support grids formed by the framework, said opening in said display having a mounting frame around the opening;
support grid in an opening where a panel has been removed; and
two mounting strips, the length of and extending the length of opposite sides of said display to secure said display by the mounting frame to the bottom side of the support grid adjacent to an opening where a panel has been removed; and
a mounting frame on said display device in which to place changeable displays.

9. The display device according to claim 8, wherein said display device has at least two sides at an angle downward from the mounting frame to permit viewing of the sides from a position beneath the display.

10. The display device according to claim 8, wherein said display device has at four sides at an angle downward from the mounting frame to permit viewing of the sides from a position beneath the display.

11. The display device according to claim 8, wherein said display is mounted below a light.

12. The display device according to claim 8, wherein said display is at least one of transparent and translucent.

13. The display device according to claim 8, wherein said display is of at least one color, and has information displayed thereon in at least one color different from the at least one color of the display.

14. A display device for use with a dropped ceiling support grid having openings therein, comprising:
a partially enclosed display having an opening therein corresponding to one of the openings in the grid, said opening in said display having edges around the opening; and
said edges mounted within and on said support grid.

15. The display device according to claim 14, including a mounting frame in which to place changeable displays.

16. A display device for use with a dropped ceiling support grid having openings therein, comprising:
a light fixture mounted in the ceiling support grid, said light fixture having a frame for mounting a lens panel; and
a partially enclosed display having an opening therein corresponding to one of the openings in the grid, said opening in said display having edges around the opening, said edges mounted within said frame, replacing said lens panel.

17. The displace device according to claim 16, wherein said frame has grooves in which the edges around the opening of said display panel are mounted.
